(19) United States
(12) Patent Application Publication
(10) Pub. No.: US 2008/0052626 A1
(43) Pub. Date: Feb. 28, 2008

(54) User interface device and method of implementing the user interface device

(75) Inventor: Kuk-hyun Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/783,635

(22) Filed: Apr. 11, 2007

(30) Foreign Application Priority Data
Jul. 11, 2006 (KR) 10-2006-0064969

(51) Int. Cl. G06F 3/00

(52) U.S. Cl. 715/721; 715/744

(57) ABSTRACT

A user interface device and method of implementing the user interface device capable of controlling a display device are provided. The user interface device provides a single integrated user interface capable of displaying information regarding image data such as broadcast program information and has a function of controlling the display device for a user, thereby providing the user interface device and method of implementing the user interface device which can be intuitively and easily used by the user.

### CROSS-REFERENCE TO RELATED PATENT APPLICATION

This application claims priority from Korean Patent Application No. 10-2006-0064969, filed on Jul. 11, 2006, in the Korean Intellectual Property Office, the disclosure of which is incorporated herein by reference in its entirety.

### BACKGROUND OF THE INVENTION

1. Field of the Invention

Devices and methods consistent with the present invention relate to a user interface, and more particularly, to a user interface device and method of implementing the user interface device capable of being used to easily and intuitively control a display device.

2. Description of the Related Art

Recently, apart from existing analog broadcasting, digital broadcasting that provides high-quality moving image services using digital data has been provided. Digital broadcasting has an advantage in that the number of available channels is much larger than in existing analog broadcasting. Analog broadcasting uses a different frequency for each channel, so that the available frequency range is limited. On the contrary, in digital broadcasting, a plurality of broadcast programs can be multiplexed in a channel. Therefore, digital broadcasting can use a larger number of channels than analog broadcasting.

In order to provide information about digital broadcast programs that are provided to a user on many channels, a broadcasting station provides a large amount of information regarding digital broadcast programs to the user through an electronic program guide (EPG). For example, the broadcast station provides information about kinds of programs that are currently being broadcast, broadcast channels, starting times of broadcast programs that are to be provided, and terminal times thereof through the EPG. The user may view digital broadcast program information displayed on a screen of a display device such as a digital television (TV) and may then select a broadcast program that the user wants to watch by using a physical interface such as a remote control.

However, according to the related art, after the user views the digital broadcast program information displayed on the screen of the digital broadcast receiver, the user has to use a channel up/down key, or a button of the remote control corresponding to a channel that the user wants, in order to change a channel. In other words, according to the related art, there is a problem in that the user has to additionally manipulate the remote control while viewing the digital broadcasting program information that is displayed on the display device.

In addition, according to the related art, there is a problem in that, the digital broadcast program information provided by the EPG is not intuitive, so that it is difficult to select a desired broadcast program from among broadcast programs provided via a lot of channels for a person who is not used to manipulating the device.

### SUMMARY OF THE INVENTION

The present invention provides a user interface device and a method of implementing the user interface device in which a user can easily find a channel on which a desired broadcast program is being broadcast, even though the user does not thoroughly search broadcast program information displayed by a display device.

The present invention also provides a user interface device and method of implementing the user interface device in which a unit for providing information about broadcast programs to a user and a unit for controlling a display device are integrated in order to be intuitively and easily used by the user.

According to an aspect of the present invention, there is provided a user interface device for controlling a display device, the user interface device comprising: a communication unit receiving information regarding image data displayed on the display device; a graphic user interface (GUI) generator generating a GUI having the received information regarding image data and predetermined control keys for controlling the display device; a display unit displaying the generated GUI; an input unit selecting a specific area of the displayed GUI; and a control unit generating a control signal for controlling the display device according a selected position of the GUI.

The communication unit may transmit the generated control signal to the display device.

The display device may be a digital broadcast reception device, and the communication unit may receive digital broadcast program information of each channel which is currently being broadcast from the digital broadcast reception device.

The GUI generator may use the received digital broadcast program information of each channel to generate the GUI including channel names and program names.

The GUI generator may divide an area of the display unit and generate the GUI in order to display the received digital broadcast program information of each channel and a predetermined control key in the divided areas.

The input unit may comprise a touch sensor sensing when a divided area is touched.

The display unit may further comprise: a screen displaying the generated GUI; a switching panel having switches which are provided to the divided areas of the GUI displayed on the screen and are turned on/off by a predetermined auxiliary input device; and a predetermined metal plate.

The auxiliary input device may be made of a magnetic material and may be attachable to the screen by magnetic interaction with the metal plate.

When the auxiliary input device is disposed on a divided area of the GUI, a switch provided to the divided area may be turned on.

According to another aspect of the present invention, there is provided a method of implementing a user interface for controlling a display device, the method comprising: receiving information regarding image data displayed on the display device; generating a GUI having the received information regarding image data and control keys for controlling the display device; displaying the generated GUI; determining whether or not a specific area of the displayed GUI is selected; and generating a control signal for controlling the display device according to the selected area when the specific area of the GUI is selected.

### BRIEF DESCRIPTION OF THE DRAWINGS

Aspects of the present invention will become more apparent by describing in detail exemplary embodiments thereof with reference to the attached drawings, in which:

FIG. 1 is a view for explaining a concept of a user interface device according to an exemplary embodiment of the present invention;

FIG. 2 is a view showing a user interface device according to an exemplary embodiment of the present invention;

FIG. 3 is a block diagram showing a structure of a user interface device according to an exemplary embodiment of the present invention;

FIG. 4 is a view showing an example of a graphic user interface (GUI) generated by the GUI generator illustrated in FIG. 3;

FIG. 5 is a detailed view showing a structure of a display unit illustrated in FIG. 3;

FIGS. 6A, 6B, 6C and 6D are views for explaining an operation method of a user interface device according to an exemplary embodiment of the present invention; and

FIG. 7 is a flowchart showing a method of implementing a user interface according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the attached drawings. In addition, for convenience of description, a user interface device according to an exemplary embodiment of the present invention applied to a digital broadcast display device having a function of receiving and displaying a digital broadcast will be described. However, the user interface device according to the present invention is not limited to the exemplary digital broadcast display device, but may be modified in user interface devices for controlling various multimedia devices.

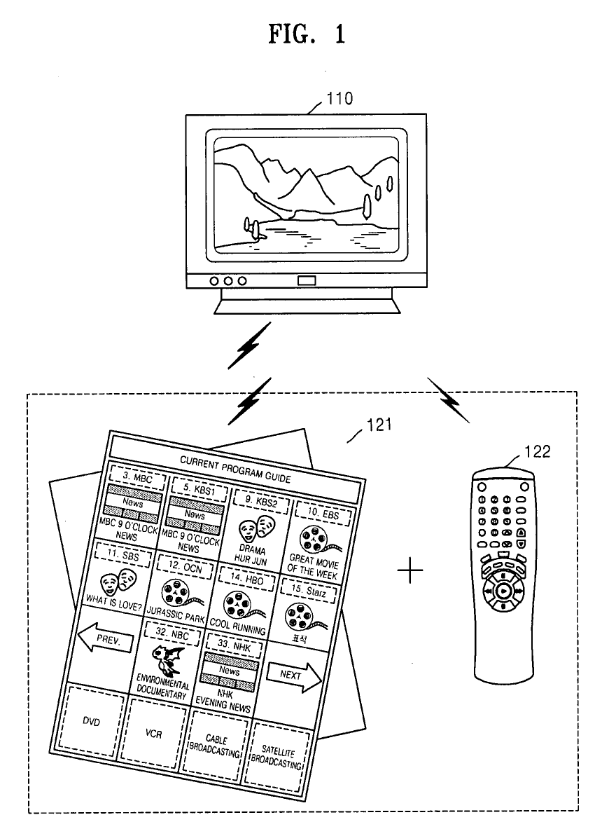

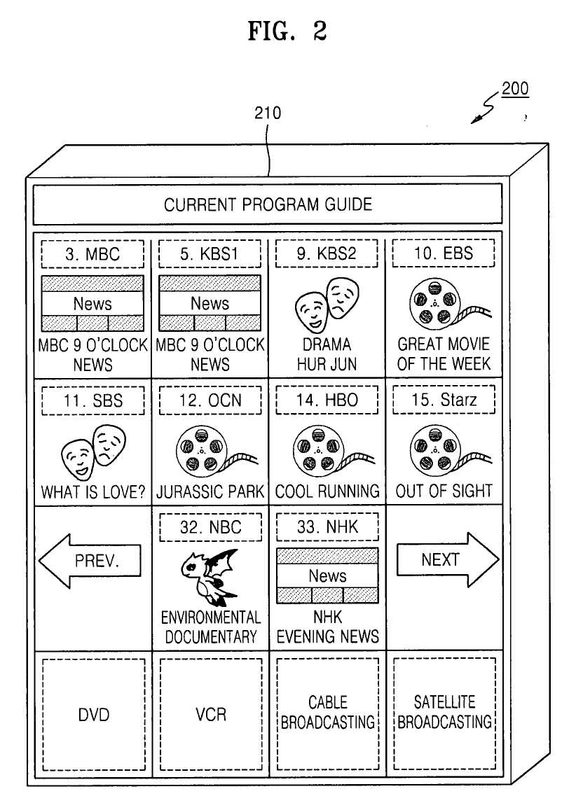

FIG. 1 is a view for explaining a concept of a user interface device according to an exemplary embodiment of the present invention. FIG. 2 is a view showing a user interface device according to an exemplary embodiment of the present invention.

A user interface device according to an exemplary embodiment of the present invention integrates broadcast program information 121 and a remote control 122 for controlling a display device 110 in order to provide information regarding broadcast programs to a user, and at the same time, has a function of controlling the display device 110, thereby providing an integrated user interface. As described above, conventionally, a user views broadcast program information 121 provided by the display device 110, and then has to select a broadcast program that the user wants to watch by using the additionally provided remote control 122.

In order to solve the aforementioned problem, and others, as shown in FIG. 2, the present exemplary embodiment provides a user interface device 200 integrating an information providing interface and a controlling interface, which are separated, in order to be intuitively and easily used. As described below, the user interface device 200 according to an exemplary embodiment of the present invention provides information regarding broadcast programs that are currently broadcast on channels and a predetermined control key for controlling a display device as a graphic user interface (GUI) 210. When a user selects a specific area of the GUI 210, the user interface device 200 generates a control signal corresponding to the selected specific area and transmits the control signal to the display device, thereby providing a function of providing the information regarding broadcast programs and a function of controlling the display device to a user through the integrated user interface.

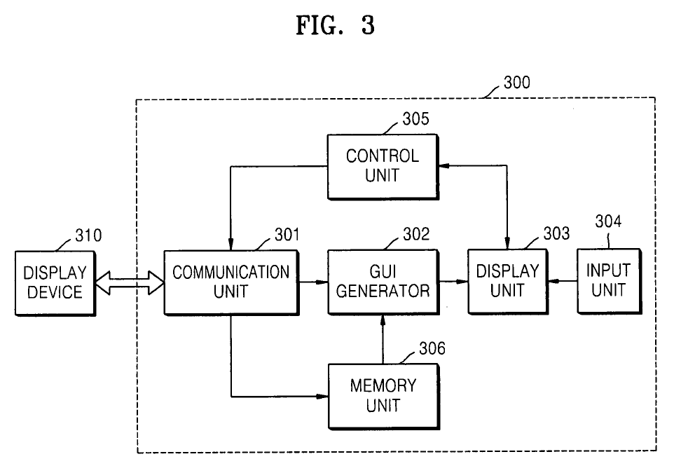

FIG. 3 is a block diagram showing a structure of a user interface device according to an exemplary embodiment of the present invention.

Referring to FIG. 3, the user interface device 300 according to the present exemplary embodiment includes a communication unit 301, a GUI generator 302, a display unit 303, an input unit 304, a control unit 305, and a memory unit 306.

The communication unit 301 receives information regarding image data displayed on the display device 310 from the display device 310 and transmits a control signal, which is generated by the selection of a specific area of a GUI displayed on the display unit 303, to the display device 310 as described below. In this case, when it is assumed that the display device 310 is a digital TV device having a function of receiving digital broadcast signals, the image data may be digital broadcast program information that is generated by using an electronic program guide (EPG) included in the received digital broadcast signals. The digital broadcast program information received from the display device 310 may include, for instance, a name of a program that is currently broadcast on each channel and a name of the corresponding channel, and a starting time and an ending time of a program of each channel. The communication unit 301 may directly receive the digital broadcast signals and generate digital broadcast program information by using the EPG data included in the digital broadcast signals.

The GUI generator 302 generates a GUI that can be easily and intuitively recognized by a user by using the received digital broadcast program information.

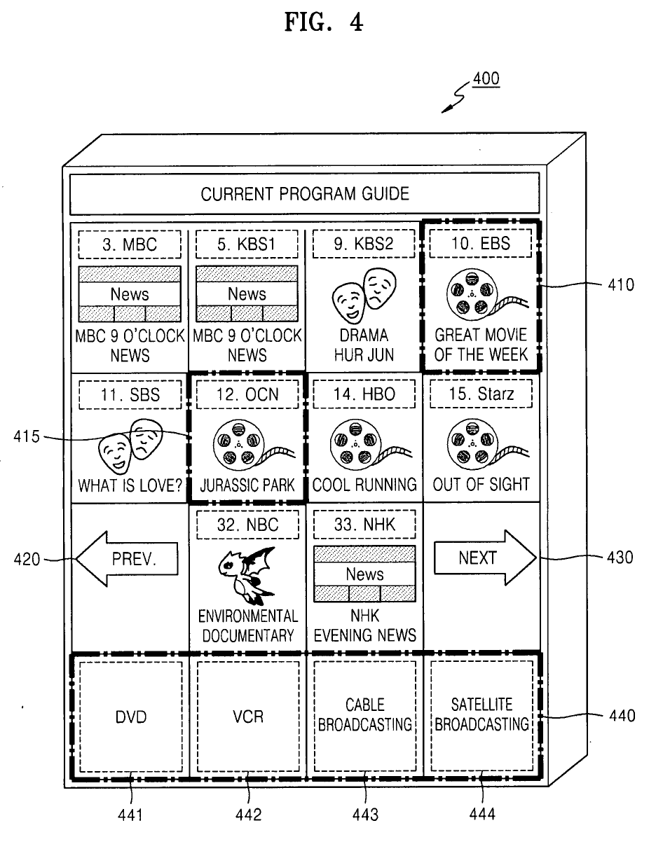

FIG. 4 is a view showing an example of a GUI generated by the GUI generator 302 illustrated in FIG. 3.

Referring to FIG. 4, the GUI 400 includes areas divided by a grid, and the area shows broadcast program information of each channel that is currently being broadcast. The area divided by the grid may be provided with a control key for controlling the display device 310 along with the information regarding the particular broadcast program.

Broadcast program information of each channel shown on each grid area includes, but is not limited to, information regarding a channel number, a channel name, a predetermined icon representing a genre of a program that is broadcast, a name of the broadcast program, or the like. For example, broadcast program information shown in a grid area 410 shows that a broadcast program having a title of “Great Movie of the Week” is broadcast on EBS channel number 10. A film-shaped icon positioned at the center of the grid area 410 shows that the program that is currently being broadcast on EBS channel 10 is a movie. Icons relating to kinds of broadcast programs use icon images according to the type of the broadcast programs, which are stored in the GUI generator 302 in advance, or use icon images corresponding to the kinds of broadcast programs of the channels transmitted from the memory unit 306.

As described above, each grid area of the GUI 400 may be formed so as to include broadcast program information regarding a channel number, a channel name, a broadcast program name, or the like. The aforementioned broadcast program information shown in each grid area is only an example. Therefore, each grid area may additionally include various information such as information regarding a starting time and ending time of the corresponding broadcast program. However, when a GUI for changing channels is provided, the GUI may include only information regarding a channel number, a channel name, a broadcast program name, or the like, which are needed to change a channel by a user, rather than program information in complicated form such as that shown in the existing EPG. In this case, the user can intuitively select a desired broadcast program from among a plurality of channels.

Since the digital broadcast programs are provided on at least tens, or hundreds of channels, broadcast program information regarding all channels that are currently broadcast may not be displayed on a single screen. Therefore, a previous screen selection key 420 and a next screen selection key 430 may be added to the GUI 400 so as to display broadcast program information of other channels that is not displayed on a single screen. In addition, similar to a scrollbar, which is used when all the information cannot be displayed in a single window of a program that uses a window system, a vertical scrollbar may be added to the left or right side of the GUI 400, or a horizontal scrollbar may be added to the top or bottom of the GUI 400. The user can then drag a scrollbox so as to vertically or horizontally move the broadcast program information of each channel in order for it to be displayed.

In addition, the GUI 400 according to the present exemplary embodiment may include external input selection keys 440. In a related art user interface method using the existing remote control, the user may feel uncomfortable selecting an external input. Therefore, as shown in FIG. 4, the GUI 400 may display the external input selection keys 440 at the lower portion thereof. For example, as shown in FIG. 4, the external input selection keys 440 may include keys for selecting an external image signal received from a DVD 441, a VCR 442, a cable broadcasting 443, or a satellite broadcasting 444.

The aforementioned structure of the GUI 400 is only an example, and a content of broadcast program information of each channel and a displayed position or form of the control key displayed for controlling the display device 310 may be easily modified consistent with the present invention. In addition, instead of dividing the area of the GUI 400 by a grid, the area of the GUI 400 may be divided into circular-shaped areas, such as a dial, or areas in various shapes, so as to display the broadcast program information and the control key thereon.

Returning to FIG. 3, the display unit 303 displays the GUI generated by the GUI generator 302.

When a part of the body of the user, or an object, contacts a specific area of the GUI 400 that is displayed on the display unit 303, the input unit 304 detects coordinates of a contacting position and transmits the position information regarding the selected area to the control unit 305.

The input unit 304 may be integrated with the display unit 303 so as to be used as a touch screen having a touch sensor for sensing the area selected by the user. As a touch panel used for the touch screen, there are, for instance, a resistive touch panel, an optical touch panel, a capacitive touch panel, an ultrasonic touch panel, and piezo touch panel. For example, when a piezo touch panel is used, a transparent piezo plate constructed with piezo cells on a grid pattern is disposed on the display unit 303 so as to construct the touch panel. When the user presses a specific area of the GUI 400, an electrical signal is generated in the piezo cell of the position pressed by the user, so that the position pressed by the user is detected as vertical and horizontal coordinates of the piezo cell by using the generated electrical signal, thereby detecting the area of the GUI selected by the user.

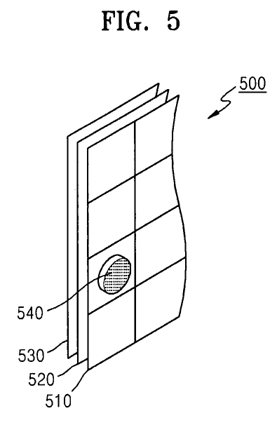

FIG. 5 is a view showing an example of a structure of a display unit 303 illustrated in FIG. 3.

As described above, when a GUI displaying broadcast program information of each channel is generated on the area divided by the grid, information regarding the selected area is more important than the exact coordinates of the position selected by the user. Therefore, as shown in FIG. 5, the display unit 500 may be constructed so as to include a screen 510 displaying a generated GUI, a switching panel 520 having switches that are provided to the divided areas of the GUI displayed on the screen 510, and turned on/off by predetermined auxiliary input devices 540, and a metal plate 530. The auxiliary input device 540 is a magnetic material and is attachable to the screen 510 by an interaction with the metal plate 530. As a simple example, a magnet may be used as the auxiliary input device 540. When the user puts the auxiliary input device 540 on a desired grid area, the auxiliary input device 540 is attached to the screen 510 by magnetism, and a switch corresponding to the grid area is turned on by a pressure generated when the auxiliary input device 540 is attached. By means of the aforementioned process, the area selected by the user from among the divided areas of the GUI displayed on the screen 510 can be sensed.

Broadcast program information displayed on each grid of the GUI 400 may be updated only when the current broadcast program is changed. Therefore, the display unit 303 may use a display panel having a long refresh time such as ePaper display technology.

Referring back to FIG. 3, the control unit 305 generates a control signal for controlling the display device 310 according to the position of the area of the GUI selected according to a touch of the user or a predetermined auxiliary input device, and transmits the generated control signal to the communication unit 301. The control signal transmitted to the communication unit 301 is transmitted to the display device 310, and the display device 310 performs a corresponding operation according to the transmitted control signal.

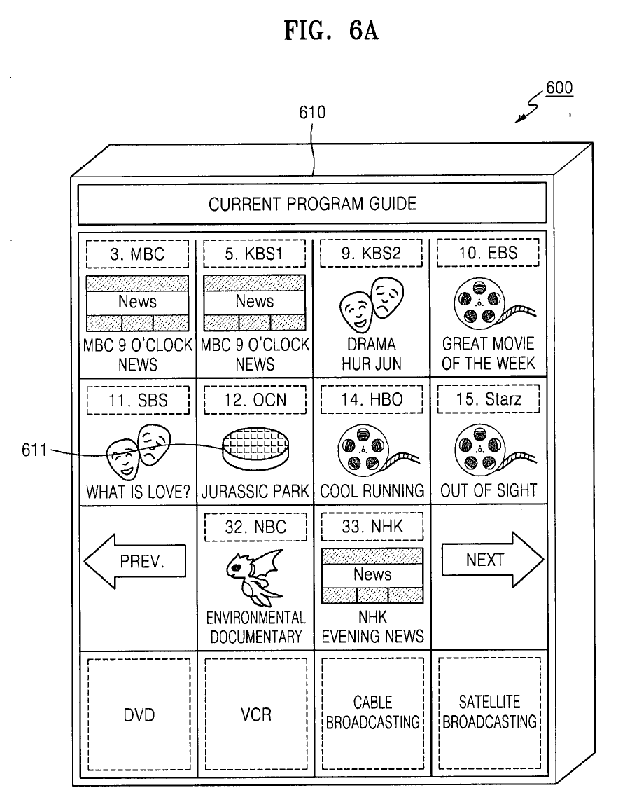

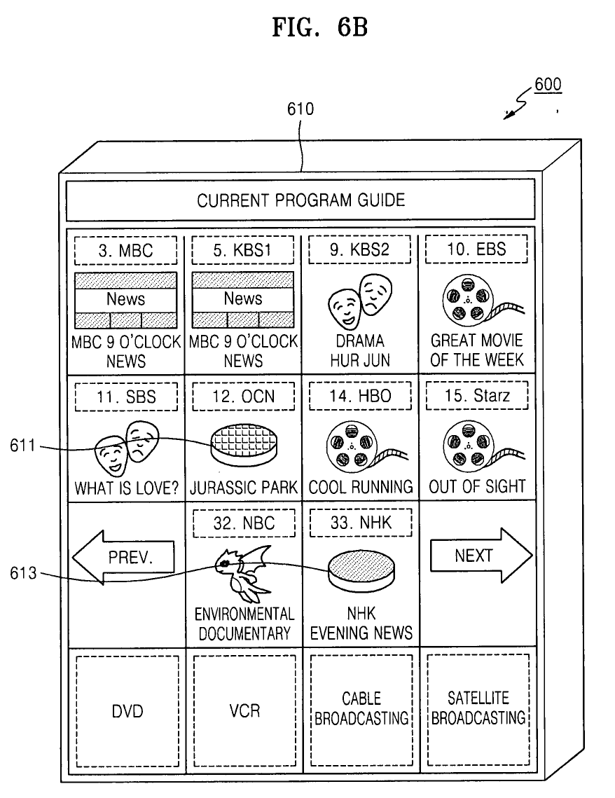

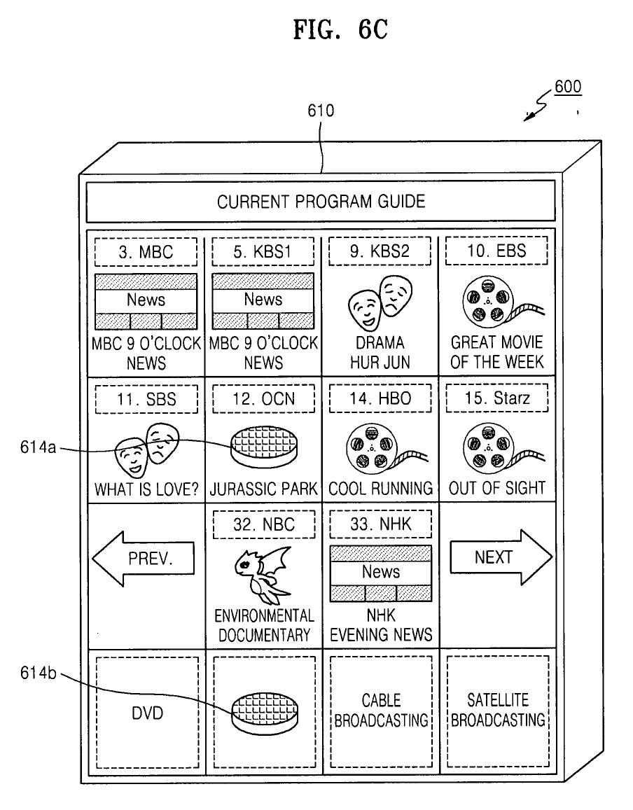

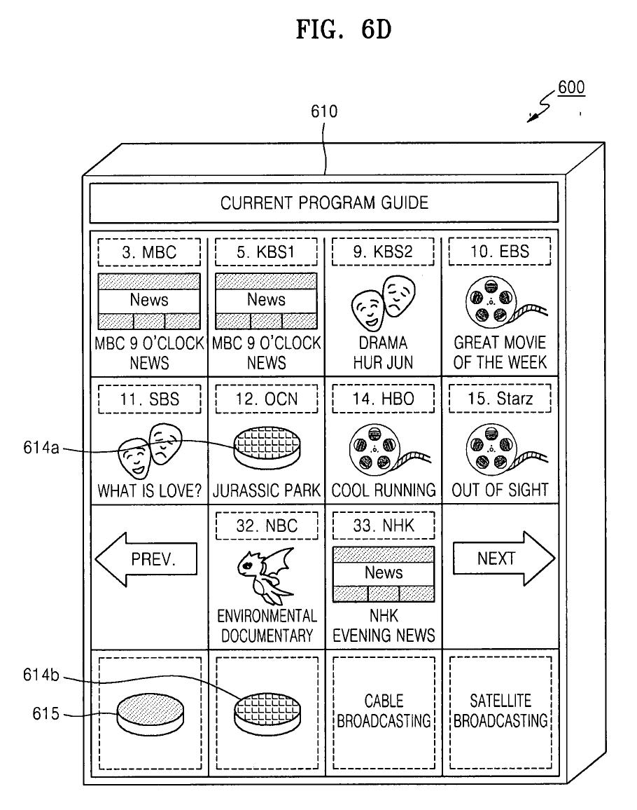

FIGS. 6A, 6B, 6C and 6D are views for explaining operation methods of a user interface device according to an exemplary embodiment of the present invention.

First, operations of the user interface, in which a user changes a channel while watching a digital broadcast program, will be described.

As described above, a user interface device 600 according to an exemplary embodiment of the present invention provides a GUI 610 showing broadcast program information of each channel to a user, as shown in FIG. 6A. The user touches a grid area of a desired broadcast program from among channels displayed on the GUI 610 with a finger, for instance, or attaches an auxiliary input device 611 to a corresponding grid area. For example, when the user wants to watch the movie “Jurassic Park” that is currently being broadcast on the OCN channel number 12, the user touches a corresponding grid area with a finger, or disposes the auxiliary input device 611 on the corresponding grid area. The control unit 305 then transmits a channel changing instruction to the display device 310 so that the current channel is changed to channel number 12 of the selected grid area, and the display device 310 that receives the channel changing instruction changes the currently displayed broadcast channel to channel number 12.

When the display device 310 has a picture-in-picture (PIP) function capable of simultaneously outputting a main screen and a sub-screen, two auxiliary input devices are used so that the one auxiliary input device selects a channel of the main screen and the other auxiliary input device selects a channel of the sub-screen. For example, referring to FIG. 6B, when the user wants to watch the movie “Jurassic Park” on channel number 12 on the main screen, and the user wants to watch the evening news of the NHK channel number 33 on the sub-screen, the user disposes a first auxiliary input device 611 for controlling the main screen on a grid area corresponding to channel number 12, and disposes a second auxiliary input device 613 for controlling the sub-screen on a grid area corresponding to channel number 33. In this case, in order to identify the auxiliary input device 611 or 613 so that the auxiliary input device 611 or 613 can control the corresponding one of the main screen and the sub-screen, an identifying means may be provided to the auxiliary input devices. For example, predetermined radio frequency identification (RFID) chips for identifying a screen that is to be controlled may by implanted in the first auxiliary input device 611 for controlling the main screen and in the second auxiliary input device 613 for controlling the sub-screen, respectively. In addition, magnetic forces of the first and second auxiliary input devices 611 and 613 for controlling the main and sub-screens, respectively, may be set to have different magnitudes so that a switch of the switching panel 520 can be selectively turned on/off. In order for the user to distinguish between the first and second auxiliary input devices 611 and 613 for controlling the main and sub-screens, respectively, the auxiliary input devices 611 and 613 may be formed to have different colors, sizes, or shapes from each other.

In another exemplary operation method, when the user wants to record a program on a specific channel by using a video cassette recorder (VCR), the user touches a grid area corresponding to the channel to be recorded and a grid area for the VCR, from among the grid areas of the GUI 610, or disposes one of the two auxiliary input devices on the grid area corresponding to the channel to be recorded and the other on the grid area corresponding to the VCR. For example, referring to FIG. 6C, when the user wants to record the movie “Jurassic Park” that is broadcast on channel number 12, by using the VCR, the user disposes an auxiliary input device 614a on the grid area corresponding to channel number 12, and disposes an auxiliary input device 614b on the grid area corresponding to the VCR.

In another exemplary operation method, when the user wants to watch a digital versatile disk (DVD) media on the sub-screen, watch a program of a specific channel on the main screen, and record the program of the specific channel by using the VCR, the user disposes an auxiliary input device for controlling the sub-screen on a grid area for the DVD and disposes two auxiliary input devices for controlling the main screen on grid areas corresponding to the channel to be recorded and the VCR, respectively. For example, referring to FIG. 6D, a second auxiliary input device 615 for controlling the sub-screen is disposed on the grid area of the DVD, and first auxiliary input devices 614a and 614b for controlling the main screen are disposed on a grid area corresponding to channel number 12 a grid area of the VCR, respectively.

In addition, the user interface device may perform various functions according to touches from the user or positions where a plurality of auxiliary input devices are disposed on the screen of the display unit 303.

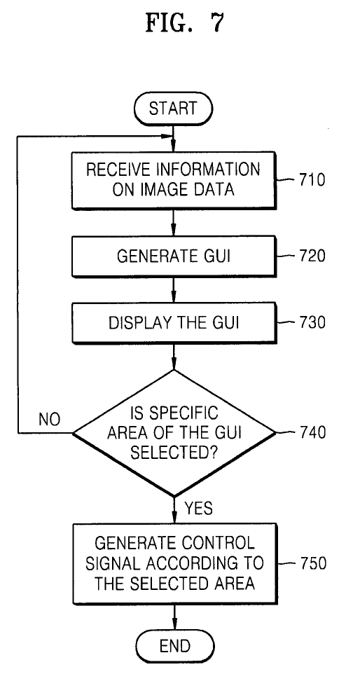

FIG. 7 is a flowchart showing a method of implementing a user interface according to an exemplary embodiment of the present invention.

In operation 710, information regarding image data displayed on the display device is received. As described above, when an exemplary embodiment of the present invention is applied to a user interface for controlling the display device having a digital broadcast reception function, the image data includes broadcast program information of each channel that is currently being broadcast.

In operation 720, a GUI including the received image data and predetermined control keys for controlling the display device is generated. As shown in FIG. 4, the GUI is formed so as to display, for example, a channel name, a channel number, a program name that is currently being broadcast, or the like on each divided grid area, so that the user can intuitively recognize which program is broadcast on each channel.

In operation 730, the generated GUI is displayed.

In operation 740, it is determined whether a specific area of the displayed GUI is selected by the user. As described above, the user touches a gird area, corresponding to a broadcast program that the user wants to watch, with a finger, or disposes a predetermined auxiliary input device on the corresponding grid area, so as to control operations of the display device including an operation of changing a channel.

In operation 750, when a specific area of the GUI is selected, a control signal for controlling the display device is generated according to the selected area, and the generated signal is transmitted to the display device.

Accordingly, broadcast program information of each channel, which can be easily understood, is provided through the GUI to the user. In addition, a desired control function is directly selected by touch or by predetermined auxiliary input devices of the GUI. Therefore, the user can intuitively and easily use the display device.

In addition, information needed by the user is provided and the display device is controlled by a single user interface. Therefore, the user can easily use the device.

The present invention may be applied to a display device such as the digital TV, but is not necessarily limited thereto, and the present invention may be employed by any device requiring a user interface. In addition, the invention can also be embodied, for example, as computer readable codes on a computer readable recording medium.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments of the present invention described above should be considered in a descriptive and illustrative sense only and not for purposes of limitation. Therefore, the scope of the invention is defined not by the detailed description of the exemplary embodiments of the invention. Rather, the scope of the invention is defined by the appended claims, and all differences within the scope of the claims will be construed as being included in the present invention.

What is claimed is:

1. A user interface device for controlling a display device, the user interface device comprising:
a communication unit which receives information regarding image data displayed on the display device;
a graphic user interface (GUI) generator which generates a GUI comprising the received information regarding image data and control keys which control the display device;
a display unit which displays the generated GUI;
an input unit which selects a specific area of the displayed GUI; and
a control unit which generates a control signal which controls the display device according a selected area of the GUI.

2. The user interface device of claim 1, wherein the communication unit transmits the generated control signal to the display device.

3. The user interface device of claim 1,
wherein the display device comprises a digital broadcast reception device, and
wherein the communication unit receives digital broadcast program information regarding each channel that is currently broadcast, from the digital broadcast reception device.

4. The user interface device of claim 3, wherein the GUI generator uses the received digital broadcast program information regarding each channel to generate the GUI, and
wherein the GUI includes channel names and program names.

5. The user interface device of claim 3, wherein the GUI generator divides an area of the GUI into a plurality of divided areas and generates the GUI to display the received digital broadcast program information regarding each channel and a control key in the divided areas.

6. The user interface device of claim 5, wherein the input unit comprises a touch sensor which senses whether at least one of the divided areas is touched.

7. The user interface device of claim 5, wherein the display unit further comprises:
a screen which displays the generated GUI;
a switching panel comprising switches which correspond to divided areas of the GUI displayed on the screen, wherein the switches are turned on and off by an auxiliary input device; and
a metal plate.

8. The user interface device of claim 7, wherein the auxiliary input device comprises a magnetic material and is attachable to the screen by magnetic interaction with the metal plate.

9. The user interface device of claim 7, wherein, if the auxiliary input device is disposed on one of the divided areas of the GUI, then a switch corresponding to the divided area is turned on.

10. The user interface device of claim 7, wherein the auxiliary input device comprises at least two auxiliary input devices which can be identified by a user so as to individually control at least two screens that are displayed on the display device.

11. The user interface device of claim 1, further comprising a memory unit which stores icon information corresponding to types of received information regarding image data and which provides the icon information to the GUI generator.

12. A method of implementing a user interface for controlling a display device, the method comprising:
receiving information regarding image data displayed on the display device;
generating a graphic user interface (GUI) comprising the received information regarding image data and control keys which control the display device;
displaying the generated GUI;
determining whether a specific area of the displayed GUI is selected; and
generating a control signal for controlling the display device according to a selected area if the specific area of the GUI is selected.

13. The method of claim 12,
wherein the display device comprises a digital broadcast reception device, and
wherein the information regarding image data includes digital broadcast program information regarding each channel that is currently broadcast.

14. The method of claim 13, wherein, in the generating of the GUI, a channel name and a program name included in the received digital! broadcast program information regarding each channel are displayed.

15. The method of claim 13, wherein the received digital broadcast program information regarding each channel is displayed on divided areas of the GUI displayed on the display unit.

16. The method of claim 12, wherein the determining whether a specific area of the displayed GUI is selected further comprises determining whether a specific area of the displayed GUI is touched.

17. The method of claim 16, wherein the specific area of the displayed GUI is selected using an auxiliary input device having magnetic characteristics.
